(19) United States
(12) Patent Application Publication
(10) Pub. No.: US 2023/0323917 A1
(43) Pub. Date: Oct. 12, 2023

(54) SOCKET JOINT AND METHOD OF MANUFACTURING

(71) Applicant: FEDERAL-MOGUL MOTORPARTS LLC, Southfield, MI (US)

(72) Inventors: Dustin Schrieber, Waterloo, IL (US); Rachael Raines, St. Charles, MO (US)

(21) Appl. No.: 17/715,554

(22) Filed: Apr. 7, 2022

(51) Int. Cl. F16C 33/74; F16J 15/32

(52) U.S. Cl. CPC F16C 33/74; F16C 2326/24; F16C 2326/05; F16J 15/32

(57) ABSTRACT

A socket joint and method of manufacture where a sealing ring is used to seat a fully elastomeric flange of a dust boot. The sealing ring has a planar sealing surface that extends between an inner diameter edge and an outer diameter edge, and the planar sealing surface rests against the elastomeric top edge of the flange and the inner diameter edge rests against a stud of the socket joint to seat the dust boot and seal the assembly. The housing of the socket joint includes a number of features within the internal bore to improve manufacturing and enhance the interference fit of the sealing ring.

### TECHNICAL FIELD

This invention generally relates to vehicle components and, in particular, to socket joints used in steering and suspension systems.

### BACKGROUND

Socket joints often include flexible dust boots that hold grease to help lubricate internal components and help seal the internal components from dust, debris, and water. Dust boots typically fit onto the housing of the socket joint in one of two ways: externally around the outside of the housing, or inside in the internal bore of the housing. The dust boots can be installed by the manufacturer or by the customer, depending on the design. External dust boots that attach to the outside of the housing require additional hardware to install and hold the boot to the housing, and can be more prone to sealing deficiencies and water intrusion as the contact point with the housing is external and exposed. Many internal/integrated dust boots require a metal or plastic insert around the base of the boot where it mates with the housing to hold it in the housing and resist it being pulled out when other components such as studs, bushings, brackets, etc. that are pushed through the assembly. Dust boots with inserts or attached reinforcement components often experience bonding issues during the molding of the parts due to material differences between the pliant hyper-elastic material of the boot, and the more rigid material of the insert. This can lead to manufacturing difficulties.

### SUMMARY

According to one embodiment, there is provided a socket joint comprising a stud and a dust boot at least partially surrounding the stud. The dust boot has a fully elastomeric flange with an elastomeric bottom edge, an elastomeric top edge, and an elastomeric side edge between the elastomeric bottom edge and the elastomeric top edge. The socket joint includes a sealing ring having a planar sealing surface that extends between an inner diameter edge and an outer diameter edge. The planar sealing surface rests against the elastomeric top edge of the flange and the inner diameter edge rests against the stud.

In some embodiments, there is a housing at least partially surrounding the stud, where the housing includes an internal bore having a flange seating surface configured to contact the elastomeric bottom edge of the flange, a flange nesting surface oriented at an angle with respect to the flange seating surface and configured to contact the elastomeric side edge of the flange, and a tapered transition surface located adjacent the flange nesting surface.

In some embodiments, the tapered transition surface is configured to retain the sealing ring during manufacture.

In some embodiments, the internal bore of the housing includes a primary internal bore surface that extends between the tapered transition surface and a cover plate groove.

In some embodiments, the flange nesting surface is at least partially oriented orthogonally with respect to the flange seating surface.

In some embodiments, the tapered transition surface is at least partially oriented at an angle between 45° and 75°, inclusive, with respect to the flange seating surface.

In some embodiments, the sealing ring is a press-fit metal washer.

In some embodiments, the sealing ring is a press-fit bearing.

In accordance with another embodiment, there is provided a socket joint comprising a stud and a dust boot at least partially surrounding the stud, the dust boot having a flange. The socket joint includes a housing at least partially surrounding the stud. The housing includes an internal bore having a flange seating surface configured to contact a bottom edge of the flange, a flange nesting surface oriented at an angle with respect to the flange seating surface and configured to contact a side edge of the flange, and a tapered transition surface located adjacent the flange nesting surface. The tapered transition surface is configured to retain a sealing ring during manufacture.

In some embodiments, the flange of the dust boot is a fully elastomeric flange such that the bottom edge is an elastomeric bottom edge and the side edge is an elastomeric side edge.

In some embodiments, the sealing ring rests against an elastomeric top edge of the flange.

In some embodiments, the sealing ring has a planar sealing surface that extends between an inner diameter edge and an outer diameter edge, and the planar sealing surface rests against the elastomeric top edge of the flange and the inner diameter edge rests against the stud.

In some embodiments, the internal bore of the housing includes a primary internal bore surface that extends between the tapered transition surface and a cover plate groove.

In some embodiments, the flange nesting surface is at least partially oriented orthogonally with respect to the flange seating surface.

In some embodiments, the tapered transition surface is at least partially oriented at an angle between 45° and 75°, inclusive, with respect to the flange seating surface.

In some embodiments, the sealing ring is a press-fit metal washer.

In some embodiments, the sealing ring is a press-fit bearing.

In accordance with one embodiment, there is a method of manufacturing a socket joint comprising the steps of: inserting a dust boot into an internal bore of the housing, with the dust boot being configured to rest against a flange seating surface in the housing; inserting a sealing ring into the internal bore of the housing; pressing the sealing ring into the dust boot; and inserting a stud into the internal bore of the housing so that the dust boot and the sealing ring rest against the stud.

In some embodiments, the sealing ring is configured to rest against a tapered transition surface before the pressing step.

In some embodiments, the sealing ring has a planar sealing surface that rests against a top edge of a flange of the dust boot and an inner diameter edge that rests against the stud.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### BRIEF DESCRIPTION OF THE DRAWINGS

Preferred example embodiments will hereinafter be described in conjunction with the appended drawings, wherein like designations denote like elements, and wherein:

FIG. 1 is a cross-section view of a socket joint according to one embodiment;

FIG. 2 is an enlarged view of a portion of the socket joint of FIG. 1;

FIG. 3 is an exploded view of the socket joint of FIGS. 1 and 2;

FIG. 4 is a perspective view of the sealing ring from the socket joint of FIGS. 1-3; and

FIG. 5 is a side view of another embodiment of a sealing ring.

### DETAILED DESCRIPTION

The socket joints and manufacturing methods described herein can improve the seal of the dust boot within the assembly, while streamlining manufacturing efforts. The dust boot is internally seated in the housing of the socket joint, without an integrally attached or embedded insert. Thus, the dust boot can be made of a single, elastomeric material. To adequately seat the dust boot and create a sealing engagement with the other internal components of the joint assembly, a press-fit sealing ring is used. There is opportunity for cost savings with respect to both the direct component cost, as well as in manufacturing ease as the cost for making the dust boots is reduced by elimination of the insert and the bonding steps. The dust boot itself is less expensive than other internally seated boots, due to the lack of insert and otherwise simple design.

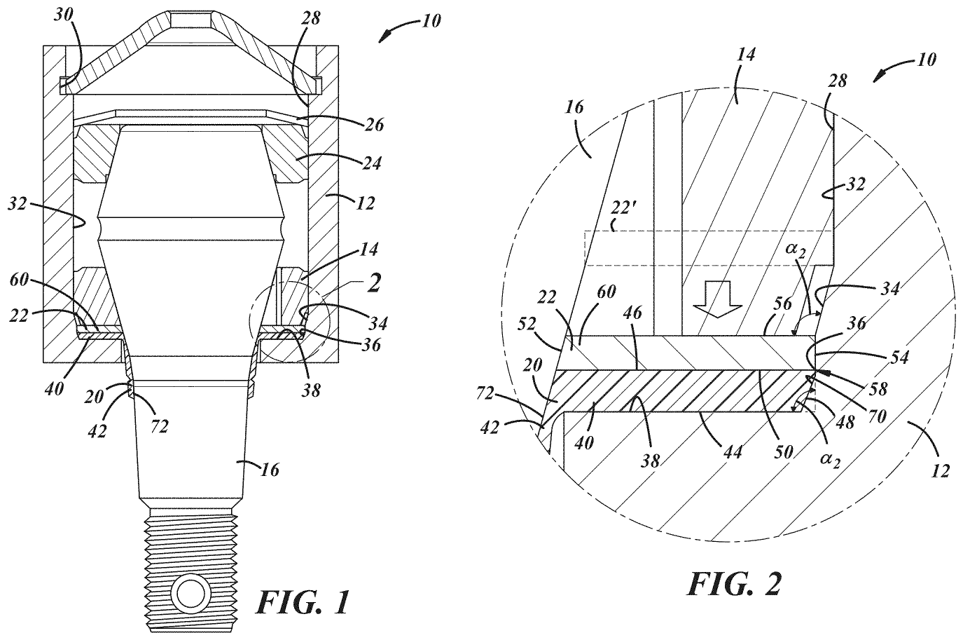

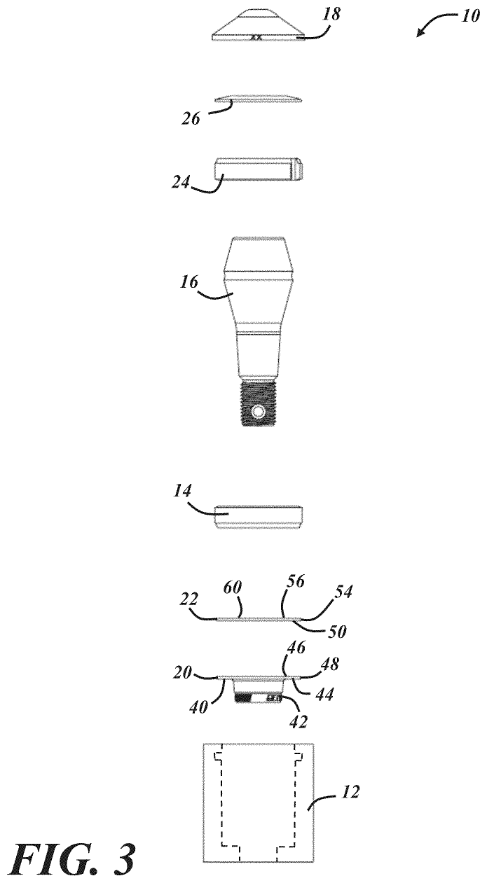

FIGS. 1-3 illustrate one embodiment of a socket joint 10. The socket joint 10 includes a housing 12 at least partially surrounding a bearing 14 and a stud 16. A cover plate 18 and a dust boot 20 are used to help seal the internal components of the joint 10, and a sealing ring 22 is used to help seat the dust boot 20 in place within the housing 12. Other features may also be included, such as the illustrated second bearing 24 and Belleville washer 26. The socket joint 10 may also include other features, such as a pressure cup or other operational-based features depending on the desired use and placement of the joint within a vehicle steering and suspension system.

The housing 12 is a generally circular cylindrical component that surrounds the internal components of the joint 10. The housing 12 has an internal bore 28 in which the bearing 14, stud 16, cover plate 18, dust boot 20, and sealing ring 22 are situated. The internal bore 28 includes a groove 30 for seating the cover plate 18, a primary internal bore surface 32, a tapered transition surface 34, a flange nesting surface 36, and a flange seating surface 38. The tapered transition surface 34, the flange nesting surface 36, and the flange seating surface 38 are shown more particularly in FIG. 2, and detailed further below.

The dust boot 20 includes a radially extending flange 40 extending from an axially extending body 42 that surrounds and seals the stud 16 and the other internal components of the socket joint 10. One advantage of the embodiments described herein is that the dust boot 20 has a fully elastomeric flange 40 and body 42 with the flange being internally seated within the housing 12. More particularly, the dust boot 20 is made from a single elastomeric material, and is accordingly easier to manufacture and less likely to delaminate from an attached or integrated metal component. For example, some dust boots include a vulcanized or otherwise permanent or semi-permanent attached metal reinforcement component. Others include a metal insert that is embedded or otherwise molded with the elastomeric flange. These embodiments are more prone to delamination or the like, and a fully elastomeric dust boot 20 is easier to manufacture. In an advantageous embodiment, the dust boot 20 is made entirely of neoprene, polyester, polyurethane, or some other rubber-like material. Moreover, the dust boot 20 material may have fillers of various compositions or the like, but by “fully elastomeric” it is meant that the dust boot 20 does not have a structural metal component that is attached or embedded within the flange 40 or the body 42.

The flange 40 of the dust boot 20 includes an elastomeric bottom edge 44, an elastomeric top edge 46, and an elastomeric side edge 48 that defines the outer circumference or perimeter of the dust boot flange 40 and connects the bottom edge and the top edge. The elastomeric bottom edge 44 directly contacts the flange seating surface 38 of the housing 12, and the elastomeric top edge 46 directly contacts the sealing ring 22. The elastomeric side edge 48 directly contacts the flange nesting surface 36 of the housing 12. Having the fully elastomeric flange 40 with the elastomeric bottom edge 44, the elastomeric top edge 46, and the elastomeric side edge 48 provides for increased flexibility and compressibility, particularly once the flange 40 is seated between the flange seating surface 38 and the sealing ring 22. As compared with inserts having a vulcanized or otherwise more permanently attached or inserted metal component, the elastomeric flange 40 has the potential to shear or expand further into the space between the flange seating surface 38 and the sealing ring 22, which can improve the seal of the dust boot 20. In some embodiments, this expansion can be on the order of 150% or more, which can help improve sealing performance.

The sealing ring 22 is used to secure the flange 40 of the dust boot 20 with respect to the housing 12. The sealing ring 22 is a component that is wholly external and separate from the boot 20, and can either be a new component to the assembly for retention, or an existing press-fit component that is already present in the assembly and presses right on top of the boot. The sealing ring 22 includes a planar sealing surface 50 that extends between an inner diameter edge 52 and an outer diameter edge 54. A top surface 56 of the sealing ring 22 rests directly against the bearing 14. The planar sealing surface 50 allows for the seating ring 22 to be easily press-fit in place against the flange 40 to create a non-bonded elastomeric-metallic interface 58 between the ring and the flange. This arrangement is advantageous, as it does not involve any additional crimping manufacturing steps or steps to more integrally attach a metal sealing component to the dust boot 20. Moreover, as illustrated, the planar sealing surface 50 is configured to contact only a single edge of the edge of the dust boot 20 (the elastomeric top edge 46) which can provide additional elastomeric material to interface with the stud 16 and housing 12.

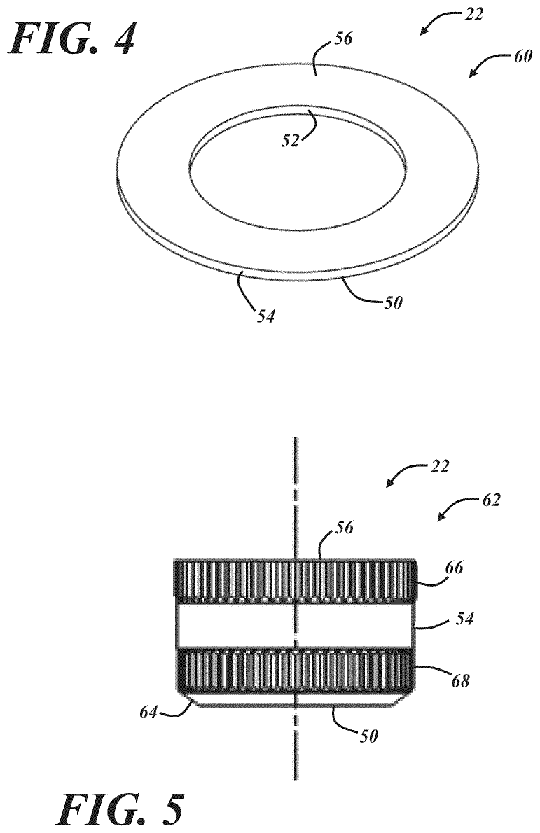

With reference to FIGS. 4 and 5, the sealing ring 22 may be a press-fit washer 60 or a press-fit bearing 62 for example, depending on the desired implementation. The press-fit washer 60 is used in the embodiments illustrated in FIGS. 1-4, and the example press-fit bearing 62 is shown in FIG. 5. Both the washer 60 and bearing 62 are made of a metal-based material, such as steel, to maintain sufficient rigidity while they are pressed against the fully elastomeric flange 40. With the washer 60 in FIG. 4, the planar sealing surface 50 extends entirely between the inner diameter edge 52 and the outer diameter edge 54. With the bearing 62 in FIG. 5, the planar sealing surface 50 still extends between the inner diameter edge and the outer diameter edge 54, yet there is a small taper 64 adjacent the outer diameter edge 54. This may be used to accommodate a diametric reduction in the housing, yet would still result in an entirely planar sealing surface 50 to contact the flange 40. In other embodiments, the taper 64 may be the planar sealing surface 50 between the inner diameter edge and the outer diameter edge 54. The bearing 62 also has two knurled circumferential areas 66, 68 that separately extend around the outer diameter edge 54, each of which can help provide an interference fit with the housing 12. The bearing 62 may be an advantageous embodiment, as it eliminates an additional component (e.g., the bearing 14 and the washer 60 in FIG. 1 can be replaced with the bearing 62).

Returning to FIGS. 1 and 2, manufacturing the socket joint 10 with the dust boot 20 and the sealing ring 22 can be easier and more cost effective than other methods, such as having a metal ring attached to or embedded within the dust boot. During manufacture, the dust boot 20 is dropped into the housing 12. The structure of the internal bore 28 of the housing 12 is particularly configured to accommodate the fully elastomeric dust boot 20 and the sealing ring 22. More specifically, the non-pressed dust boot 20 drops all the way to directly contact the flange seating surface 38, whereas the more rigid sealing ring 22 is sized such that it stops at the tapered transition surface 34 of the internal bore 28, as represented by reference numeral 22′ and shown in dotted lines in FIG. 2. The tapered transition surface 34 is oriented at an angle α1 that is between 45° and 75°, inclusive, with respect to the flange seating surface 38 (for clarity purposes, angle α1 is shown in FIG. 2 with respect to the top surface 56 of the ring 22, which is parallel to the flange seating surface 38). More particularly, the angle α1 is 60°. This radial tapering and diametric reduction of the internal bore 28 provides a transition area for the sealing ring 22′ to be pressed into its final position to rest directly against the elastomeric top edge 46 of the flange 40 of the dust boot 20. Moreover, this diametric reduction in the internal bore 28 helps provide a better interference fit between the sealing ring 22 and the housing 12 to better hold and mechanically lock the dust boot 20 into place. Accordingly, the flange nesting surface 36 is diametrically reduced with respect to the primary internal bore surface 32, to better accommodate the interference fit between the sealing ring 22 and the housing 12. Additionally, both the tapered transition surface 34 and the flange nesting surface 36 are diametrically reduced with respect to the pre-pressed outer diameter edge 54 of the sealing ring 22′.

In terms of configurations of the internal bore 28 of the housing 12 to better accommodate the fully elastomeric flange 40 of the dust boot 20 and the sealing ring 22, the flange nesting surface 36 is also at least partially oriented at an angle α2 which is orthogonal with respect to the flange seating surface 38. This provides a more planar sealing area which can result in a more uniform expansion of the flange 40 when it is pressed into place against the housing 12 and the sealing ring 22, particularly given the configuration of the planar sealing surface 50 of the sealing ring 22. The flange nesting surface 36 additionally includes another slightly tapered surface 70 directly adjacent the flange seating surface 38, which may or may not be included depending on the desired implementation. While not required, this second tapered surface 70 can be used to better accommodate tooling during manufacture or to more tightly constrain the flange 40, to cite a few examples.

After the sealing ring 22′ is dropped into the housing, it is physically press-fit down against the tapered transition surface 34 until the outer diameter edge 54 rests directly against the flange nesting surface 36, particularly at the portion that is oriented orthogonally with respect to the flange seating surface 38. After the press-fit step, the stud 16 is inserted into the internal bore 28 of the housing 12. As shown in FIGS. 1 and 2, the stud 16 is configured to rest directly against the internal diameter edge 52 of the sealing ring 22, as well as directly against the internal bore 72 of the dust boot 20. This can help engage the dust boot 20 in the proper position for adequate sealing of the internal components of the socket assembly 10.

It is to be understood that the foregoing is a description of one or more preferred example embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A socket joint, comprising:
a stud;
a dust boot at least partially surrounding the stud, the dust boot having a fully elastomeric flange with an elastomeric bottom edge, an elastomeric top edge, and an elastomeric side edge between the elastomeric bottom edge and the elastomeric top edge; and
a sealing ring having a planar sealing surface that extends between an inner diameter edge and an outer diameter edge, wherein the planar sealing surface rests against the elastomeric top edge of the flange and the inner diameter edge directly faces the stud.

2. The socket joint of claim 1, comprising a housing at least partially surrounding the stud, wherein the housing includes an internal bore having a flange seating surface configured to contact the elastomeric bottom edge of the flange, a flange nesting surface oriented at an angle with respect to the flange seating surface and configured to contact the elastomeric side edge of the flange, and a tapered transition surface located adjacent the flange nesting surface.

3. The socket joint of claim 2, wherein the tapered transition surface is configured to retain the sealing ring during manufacture.

4. The socket joint of claim 2, wherein the internal bore of the housing includes a primary internal bore surface that extends between the tapered transition surface and a cover plate groove.

5. The socket joint of claim 2, wherein the flange seating surface is at least partially oriented orthogonally with respect to the flange nesting surface.

6. The socket joint of claim 5, wherein the tapered transition surface is at least partially oriented at an angle between 45° and 75°, inclusive, with respect to the flange seating surface.

7. The socket joint of claim 1, wherein the sealing ring is a press-fit metal washer.

8. The socket joint of claim 1, wherein the sealing ring is a press-fit bearing.

9. A socket joint, comprising:
a stud;
a dust boot at least partially surrounding the stud, the dust boot having a flange; and
a housing at least partially surrounding the stud, wherein the housing includes an internal bore having a flange seating surface configured to contact a bottom edge of the flange, a flange nesting surface oriented at an angle with respect to the flange seating surface and configured to contact a side edge of the flange, and a tapered transition surface located adjacent the flange nesting surface, wherein the tapered transition surface is configured to retain a sealing ring during manufacture.

10. The socket joint of claim 9, wherein the flange of the dust boot is a fully elastomeric flange such that the bottom edge is an elastomeric bottom edge and the side edge is an elastomeric side edge.

11. The socket joint of claim 9, wherein the sealing ring rests against an elastomeric top edge of the flange.

12. The socket joint of claim 11, wherein the sealing ring has a planar sealing surface that extends between an inner diameter edge and an outer diameter edge, wherein the planar sealing surface rests against the elastomeric top edge of the flange and the inner diameter edge rests against the stud.

13. The socket joint of claim 9, wherein the internal bore of the housing includes a primary internal bore surface that extends between the tapered transition surface and a cover plate groove.

14. The socket joint of claim 9, wherein the flange nesting surface is at least partially oriented orthogonally with respect to the flange seating surface.

15. The socket joint of claim 14, wherein the tapered transition surface is at least partially oriented at an angle between 45° and 75°, inclusive, with respect to the flange seating surface.

16. The socket joint of claim 9, wherein the sealing ring is a press-fit metal washer.

17. The socket joint of claim 9, wherein the sealing ring is a press-fit bearing.

18. A method of manufacturing a socket joint, comprising the steps of:
inserting a dust boot into an internal bore of the housing, wherein the dust boot is configured to rest against a flange seating surface in the housing;
inserting a sealing ring into the internal bore of the housing;
pressing the sealing ring into the dust boot; and
inserting a stud into the internal bore of the housing so that the dust boot and the sealing ring directly faces the stud.

19. The method of claim 18, wherein the sealing ring is configured to rest against a tapered transition surface before the pressing step.

20. The method of claim 18, wherein the sealing ring has a planar sealing surface that rests against a top edge of a flange of the dust boot and an inner diameter edge that directly faces the stud.
